(19) United States
(12) Patent Application Publication
(10) Pub. No.: US 2024/0384375 A1
(43) Pub. Date: Nov. 21, 2024

(54) Composition for and Method of Making a Nickel-based Alloy

(71) Applicant: New Mexico Tech University Research Park Corporation, Socorro, NM (US)

(72) Inventors: Bhaskar S. Majumdar, Socorro, NM (US); Kevin W. Garber, Los Lunas, NM (US); Mohammad Tashfiul Amin Chowdhury, Socorro, NM (US); Nathaniel Badgett, Los Lunas, NM (US); John M. O'Connell, Socorro, NM (US)

(21) Appl. No.: 18/668,056

(22) Filed: May 17, 2024

Related U.S. Application Data
(60) Provisional application No. 63/467,548, filed on May 18, 2023.

(51) Int. Cl. C22C 19/00; B22F 10/28; B33Y 10/00; B33Y 70/00; C22C 19/05

(52) U.S. Cl. CPC C22C 19/007; B22F 10/28; B33Y 10/00; B33Y 70/00; C22C 19/058; B22F 2301/15; B22F 2998/10

(57) ABSTRACT

The present disclosure describes a novel nickel-based alloy comprising reduced carbon content and increased hafnium content particularly suitable for use in methods of additive manufacturing, such as three-dimensional printing. The composition described herein avoids known manufacturing challenges, such as cracking, and is associated with increased strength after being subjected to high temperatures up to 1100° C.

### BACKGROUND

The present disclosure relates to a nickel-based alloy with reduced carbon (C) content and/or increased hafnium (Hf) content. The alloy of the present disclosure is particularly suitable for use in additive manufacturing of alloys because the alloy of the present disclosure can withstand very high temperature conditions and does not exhibit cracks when additively manufactured.

One of the fastest growing sectors of the manufacturing industry is additive manufacturing (“AM”) that involves three-dimensional (3D) printing of parts or components by a gradual addition of materials in layer-by-layer method based on computer-generated model.

Additive manufacturing (AM), also known as 3D printing, is a rapidly growing manufacturing technology. It allows the production of complex geometries and near-net shapes, which can be difficult or impossible to achieve using traditional manufacturing methods. In the case of metals, the process involves building up a three-dimensional object layer-by-layer using a computer-controlled laser or electron beam to melt and fuse metal powder or wire. Key challenges of this process are extremely rapid solidification of small melt pools in high temperature-gradient fields, residual stresses imposed by the surroundings, and others. Consequently, there are many conventional alloys that are difficult to fabricate using AM because they create various defects, such as cracks.

Ni-base superalloys are high temperature alloys with Ni as the major element, and capable of performing in high temperatures (typically 600-1100° C.) under mechanical stress in air for extended time periods. These alloys contain precipitates, which determine their temperature and strength capabilities. For example, Inconel 718, with about 20-30 volume percent precipitates, can perform very well up to about 700° C., after which the strength reduces drastically. On the other hand, alloys such as MARM247, CM247 LC, Inconel 738, IN 100, etc., contain highly coherent 55-70 volume percent precipitates (called gamma-prime), and they can operate up to about 1050° C. The single crystal versions such as CMSX 10 can operate up to 1100° C. All these high-volume fraction gamma/gamma-prime alloys are conventionally cast or directionally solidified, but require careful processing to prevent defects and formation of brittle phases. A skilled artisan would be aware of these prior art compositions, processing steps, and mechanical properties at high temperature. In the realm of additive manufacturing, the low volume fraction alloys such as Inconel 718 alloy can be 3-D printed without formation of cracks, but are limited in application to about 700° C. All the high-volume fraction alloys currently exhibit solidification cracks when 3D printed. In other words, based on the present inventors' knowledge, there currently does not exist any alloy composition that can avoid the generation of cracks during conventional 3D printing processing while also meeting mechanical performance needs above 700° C.

Traditional methods of superalloy manufacturing do not disclose how to mitigate cracks in superalloys during additive manufacturing, particularly nickel-based alloys. Additionally, there does not exist a viable powder composition for fabricating crack-free superalloys using additive manufacturing technique with temperature capability higher than 700° C.

What is needed is a composition that is resistant or immune to cracking and/or a manufacturing method that prevents Ni-based superalloys from being susceptible to cracking. The alloy of the present disclosure is resistant or immune to cracking under conventional 3-D printing methods.

### BRIEF SUMMARY

The present disclosure describes an alloy or a superalloy composition comprising nickel, low or reduced carbon content (e.g., less than 0.03, less than 0.02, or less than 0.015 wt % carbon) and high or elevated hafnium content (e.g., 1.5 to 6.0, 1.5 to 4.0, 2.0 to 4.0, or 2.5 to 3.0 wt % hafnium). The inventors surprisingly found the embodiments of the composition described herein have beneficial physical characteristics, such as avoidance of cracking when used in additive manufacturing processes and tolerance of high temperatures commonly implicated in different manufacturing methods, including additive manufacturing.

The present composition may further comprise chromium (e.g., about 7 to about 12 wt %), cobalt (e.g., about 7 to about 12 wt %), tungsten (e.g., about 6.0 to 10.0 wt %), aluminum (e.g., about 3.0 to about 6.0 wt %), titanium (e.g., 0.5 to 2 wt %), tantalum (e.g., 0.5 to 4 wt %), molybdenum (e.g., 5.0 or less wt %), boron (e.g., less than 0.03 wt %), zirconium (e.g., less than 0.03 wt %), niobium (e.g., less than 2.0 wt %), and/or rhenium (e.g., less than 3.0 wt %).

The present composition may comprise less than 4000 parts per million of oxygen. In embodiments, the present composition is a powder.

The present composition is particularly suitable to be used in additive manufacturing methods. For example, an article, such as tools, toys, and other articles, may be manufactured by additive manufacturing methods using the present composition. By using the present composition in additive manufacturing methods, the articles resulting therefrom would have increased strength and durability relative to common compositions used in additive manufacturing methods.

Also disclosed herein is a method of manufacturing an article by additive manufacturing, comprising using the composition of the present disclosure, wherein the additive manufacturing is selected from the group comprising Laser Powder Bed Fusion (LPBF),

Directed Energy Deposition (DED), Electron Beam Melting (EBM), and Binder Jet Technique. One skilled in the art would be aware of these additive manufacturing techniques and the optimization steps required to utilize the composition of the present disclosure.

### BRIEF DESCRIPTION OF THE SEVERAL VIEWS OF THE DRAWINGS

FIG. 1 is a series of graphs showing the weldability of certain Ni-based alloys.

FIG. 2 is a graph showing the Scheil diagram for prior art composition IN738.

FIG. 3 is a series of images showing cracking mechanisms for prior art composition IN738.

FIG. 4 is a graph showing the high temperature properties of prior art superalloys.

FIG. 5 is a series of graphs showing equilibrium and non-equilibrium solidification of prior art compositions CM247LC and CM247LCNHf.

FIG. 6 shows the equilibrium phases that are present for alloys with either 1.4 wt. % Hf (CM247LC) or zero wt. % Hf (CM247LCNHf). The accompanied table illustrates the elemental composition of these prior art alloys.

FIG. 7 is a graph showing the Kou model to assess crack susceptibility of various alloys of prior art.

FIG. 8 is a series of photos showing an experimental procedure for alloy selection according to an embodiment of the present disclosure.

FIG. 9 is a series of photos showing a comparison of Scanning Electron Microscope (“SEM”) observations of meltpools between IN718 and CM247LC.

FIG. 10 is a series of graphs showing alloy design according to an embodiment of the present disclosure.

FIG. 11 is a high magnification image of the crack path in a meltpool of CM247 LC. The accompanied table shows the Energy Dispersive X-Ray Spectroscopy (“EDS”) point analysis of a carbide phase (spectrum 7), and illustrates that the carbide phase lining the crack path is rich in Hf and W.

FIG. 12 is a series of SEM micrographs showing cracks in both the CM247LC (with 1.4 wt % Hf) and CM247LCNHf (with zero wt. % Hf) under different processing conditions.

FIG. 13 is a series of images showing elemental maps of High Angle Grain Boundaries (“HAGB”) according to an embodiment of the present disclosure.

FIG. 14 shows the equilibrium phase diagram for a carbon-free alloy, which is an embodiment of the present disclosure.

FIG. 15 shows the Scheil diagram for the carbon-free CM247LCNC alloy, which is used to understand cracking behavior for the alloy according to an embodiment of the present disclosure.

FIG. 16 is a series of images comparing SEM microstructures and cracking of meltpools of CM247LC (with nominally 0.07 wt. % C) and a modified CM247LC with only 0.04% C.

FIG. 17 is a series of images showing SEM microstructures with no cracking according to an embodiment of the present disclosure.

FIG. 18 is a series of images showing SEM microstructures with cracking present for a composition comprising zero wt % C and zero wt % Hf.

FIG. 19 is an image showing a CMNCxHf meltpool at a processing window of 180 Watts and 600 millimeters per second (“mm/s”) according to an embodiment of the present disclosure.

FIG. 20 is an image showing a CMNCxHf meltpool at a processing window of 180 W and 800 mm/s according to an embodiment of the present disclosure.

FIG. 21 is a graph showing a crack percentage comparison of CMNCxHf and other alloys according to an embodiment of the present disclosure.

### DETAILED DESCRIPTION

Embodiments of the present disclosure relate to a composition, the composition comprising: a superalloy comprising nickel, hafnium, and a low carbon percentage. The superalloy may further comprise aluminum, titanium, tantalum, Cr, Mo, W, Ta or a combination thereof. The composition may be an alloy, superalloy, polycrystalline superalloy, or a combination thereof.

The composition may be manufactured by additive manufacturing, also known as 3-D printing without the formation of cracks during the additive manufacturing and/or printing. The composition may comprise aluminum, wherein the aluminum promotes γ′ precipitate formation during manufacturing. Other elements such as Ti and Ta may contribute to γ′-precipitate volume fraction and their strength Precipitate formation may allow the composition to withstand high temperatures under mechanical load. Superalloy cracks and/or defects may be due to the presence of carbides. Cracks and/or defects in additively manufactured superalloy may also be due to the presence of carbides and presence of carbon in the last remaining solid. The composition may comprise a high-volume fraction (>55 vol. %) of γ′ that imparts high strength to the alloy.

The method may allow superalloys for additively manufactured turbine blades and static vanes, as well as polycrystalline components with complex design morphology including functionally graded architecture. Additive manufacturing is most suited for complicated parts, often in relatively small or moderate sizes. The composition may comprise a fine microstructure that provides enhanced strength compared to conventional techniques.

The method may allow alloys to be modified to make Ni-based superalloys, with application temperatures up to 1100° C. that are 3D printable without crack formation. The method may use non-equilibrium solidification models to estimate crack vulnerability at the theoretical level and combine that with observation of crack path in laser line-scanned experimental alloys, to guide alloy selection for powder procurement. The parameters of the method may resolve crack formation in the alloy. The cracks likely occur in the use of prior art compositions because of elemental segregation during very high solidification rates in the presence of high temperature gradients, along with high stresses being generated because of the high strength of the alloys at temperature. Notably, most of the cracks occur at high angle grain boundaries (HAGB).

The term “superalloy” as used herein means an alloy capable of withstanding high temperatures, high stresses, and high oxidizing conditions.

The term “stress” as used herein means a measure of an external force acting over the cross-sectional area of an object. Stress has units of force per area: N/m² or lb/in². The unit N/m² is commonly referred to as Pascals (Pa).

The term “about” as used herein means ±10%. Accordingly, a recitation of “about 10” is inclusive of a range of 8 to 12.

The terms “Gamma Prime” or “γ” as used herein mean the precipitate of ordered face centered cubic structure (i.e., L1₂ structure) used to strengthen an alloy. Other precipitates include those of different crystal structures and may comprise a carbon (“C”) or a metal.

The present disclosure relates to high temperature Ni-based alloys. Among these alloys, IN718 is a weldable alloy and suitable for AM. However, the alloy only contains 20-30 vol. % γ′ and γ″ precipitates and loses strength beyond 650° C.-700° C. For higher temperature capability, the traditional alloys suffer from severe microcracking during AM and some solutions have been formulated using lower volume fraction γ/γ′ alloys. The present disclosure also relates to high volume fraction (55-70 vol. %) γ/γ′ strengthened alloys, with CM247LC as a particular example, and addresses approaches that may mitigate the microcracking problem. The method of the present disclosure may comprise CALculation of PHAse Diagram (“CALPHAD”) and both equilibrium and Scheil non-equilibrium analyses to understand the basic solidification issues, use of hot-tear models (Kou model) in the welding literature to predict solidification cracking in an alloy and determining microstructures leading to microcracking. Based on such mechanism understanding, minor alloy changes may be formulated for microcrack mitigation. Validation of the alloy design approach may be performed using laser line scans of arc-melted buttons and assessing the microstructure and density of cracks. The method may be used in place of procuring powders of different compositions to reduce the time and enormous cost of custom-made powders of multiple compositions. The method may produce an alloy composition derived from an CM247LC alloy, where cracking is completely eliminated in a high volume-fraction L1₂ phase strengthened alloy.

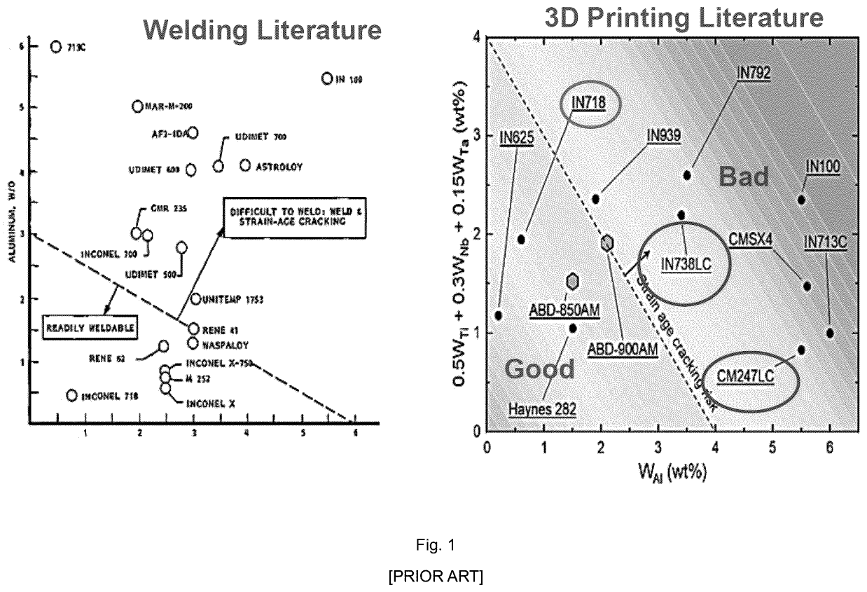

FIG. 1 shows alloys that are weldable such that there are fewer defects including,

but not limited to, cracks or porosity, during 3-D printing. Metallurgical processes associated with laser or electron beam printing and welding, specifically tungsten arc welding, are similar. FIG. 1 shows that γ′ increases high temperature strength, and therefore resists stress relaxation when melt is cooled. Cracking occurs as a consequence. As shown, aluminum (“Al”) and titanium (“Ti”) are γ′ formers.

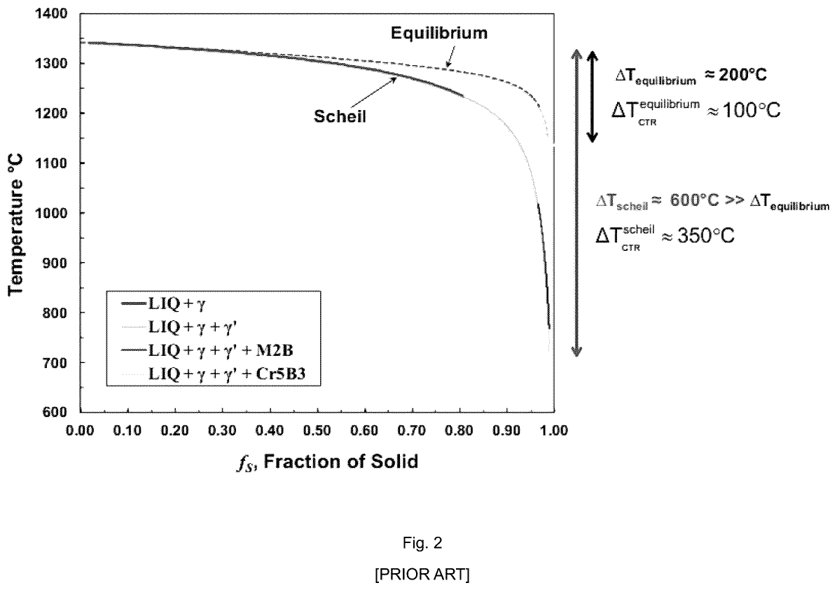

FIG. 2 shows the Scheil diagram with Temperature in Celsius along the Y-axis and Fraction of Solid along the X-axis. The Scheil diagram predicts the effective solidification temperature over a temperature range. The Scheil solidification model predicts an effective solidification temperature range of 220° C., for the alloy CM247LC and its variants when cooled under very fast non-equilibrium solidification conditions characteristic of additive manufacturing.

At much slower cooling rate that is typical of conventional casting such as sand or shell-mold casting, the solidification rate is closer to equilibrium conditions, and the solidification range is about 30° C. High solidification temperature ranges favor cracking, although other solidification parameters also contribute to cacking. Cracks may occur at high angle grain boundaries (“HAGB”) rather than at low angle grain boundaries.

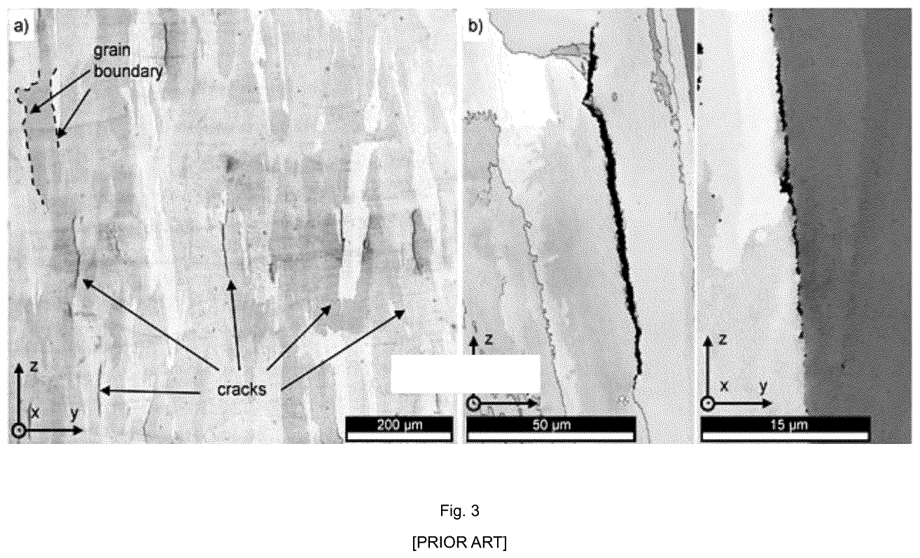

FIG. 3 shows cracking mechanisms for alloy IN738. Solidification cracks remained largely concentrated at HAGB in IN738.

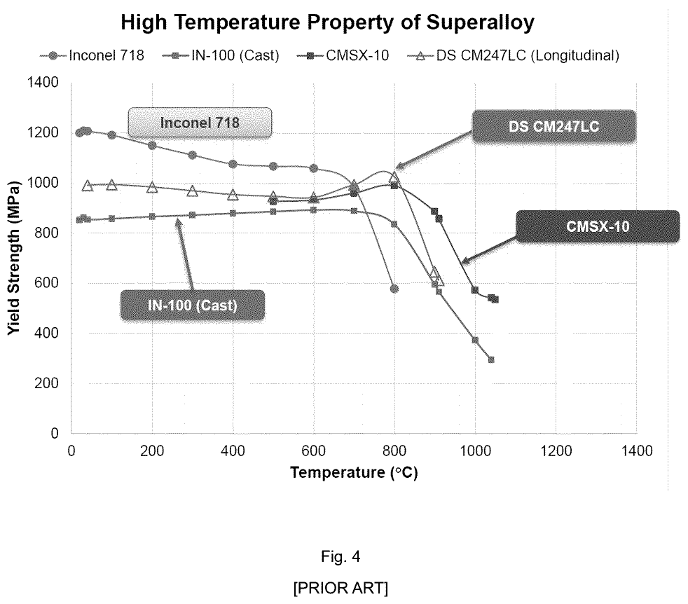

FIG. 4 shows the high temperature properties of superalloys. The IN718 alloy has γ″/γ′ volume fraction 25%-30%, and the strength drops above 700° C. DS CM247LC, CMSX-10, IN100 have >60% γ′, and similar high volume fraction alloys have temperature advantage over IN718.

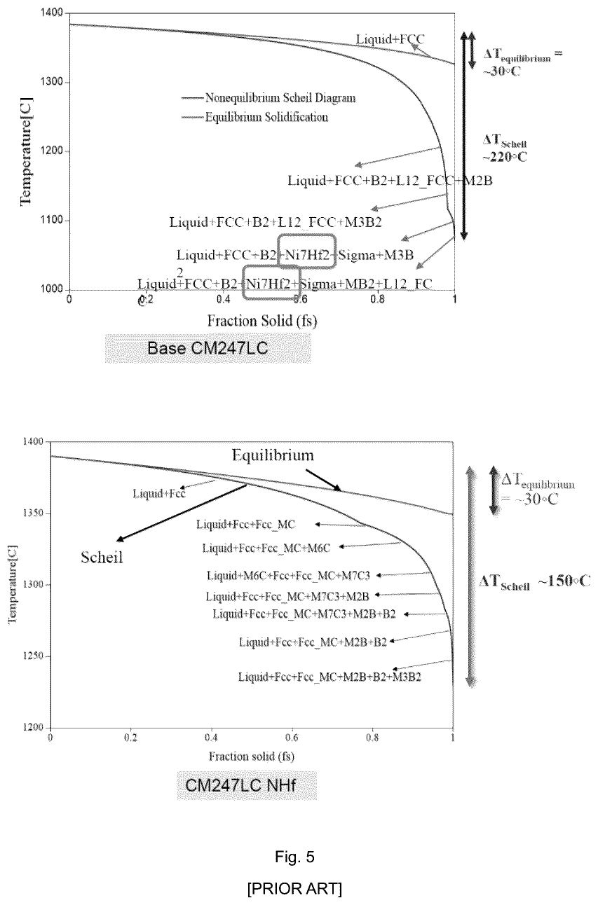

FIG. 5 shows equilibrium and non-equilibrium solidification of CM247LC and CM247LCNHf. It shows that eliminating Hf (CM247LC NHf) reduces the Scheil temperature range to 150 C. Indeed, one author (Griffith et al) claimed that CM247LC NHf eliminated cracking during 3-D printing. However, our results with the NHf alloy showed that cracking was not eliminated. Also, there are other advantages to retaining Hf in the alloy. For example, Hf is needed to prevent cracking during DS casting and Hf increases grain boundary strength and ductility of DS alloys. Hf also serves as oxide pegs to retain oxide scales and thereby enhance oxidation resistance.

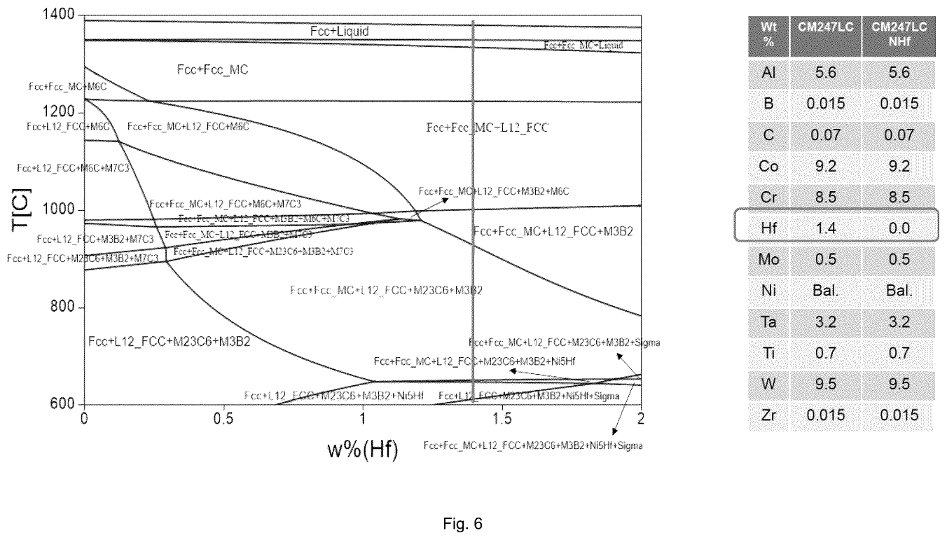

FIG. 6 shows the effect of Hf percentage on the equilibrium phase diagram for the CM247LC base composition. The CM247LC alloy comprising 1.4 wt % Hf (CM247LC) has reduced phases compared to CM247LC alloy without Hf (CM247LC NHf).

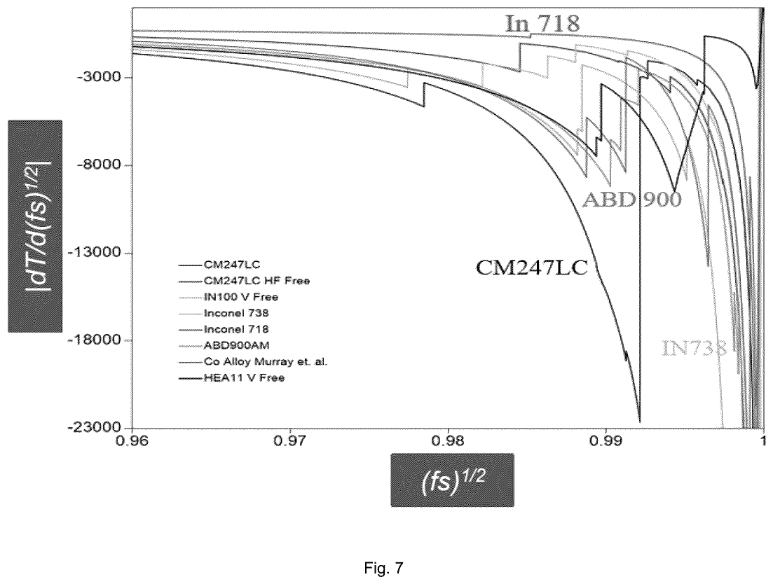

FIG. 7 shows Kou model to assess various alloys including CM247LC, CM247LC Hf Free, IN100 vanadium (“V”) Free, Inconel 738, Inconel 718, ABD900AM, Co Alloy, and HEA11 V Free. IN718 has low cracking susceptibility according to the Kou model and exhibits excellent weldability and 3-D printability. CM247LC shows a large crack susceptibility; i.e., poor printability, during rapid solidification, consistent with 3-D printing results. The IN738 alloy shows lower cracking susceptibility than CM247LC, although it exhibits poor printability. ABD900AM contains lower Al content and the volume fraction of γ′ phase is only about 40% which is not considered adequate for applications above 800° C.

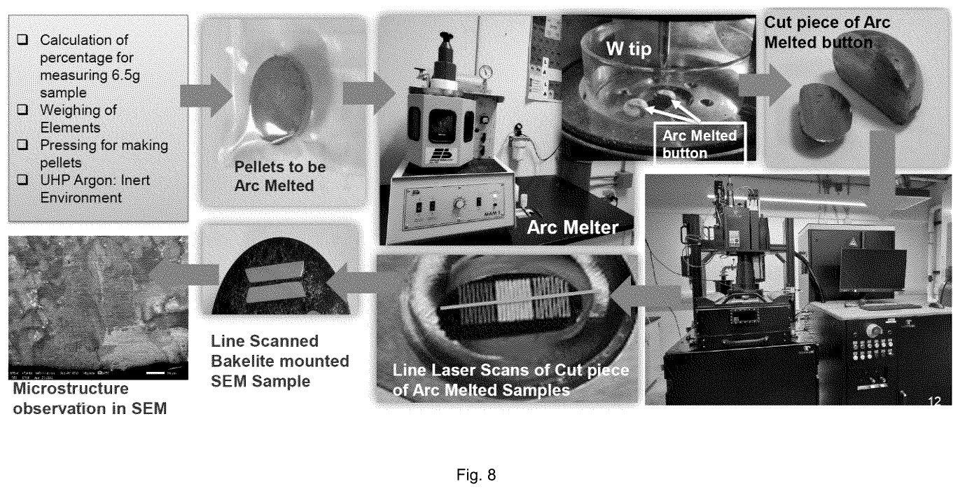

FIG. 8 shows an experimental procedure for alloy selection. Before pellets of alloy are arc melted, percentage calculations are made for 6.5 g of sample, and alloy elements are weighed and pressed into pellets in an inert environment of Ultra-high Purity (“UHP”) argon (“Ar”). Alloy pellets are melted into a button with a W tip. A piece of the button is cut, and line laser scans made of the cut piece. A sample is prepared from the cut piece for SEM imaging to observe the microstructure and cracks in the sample.

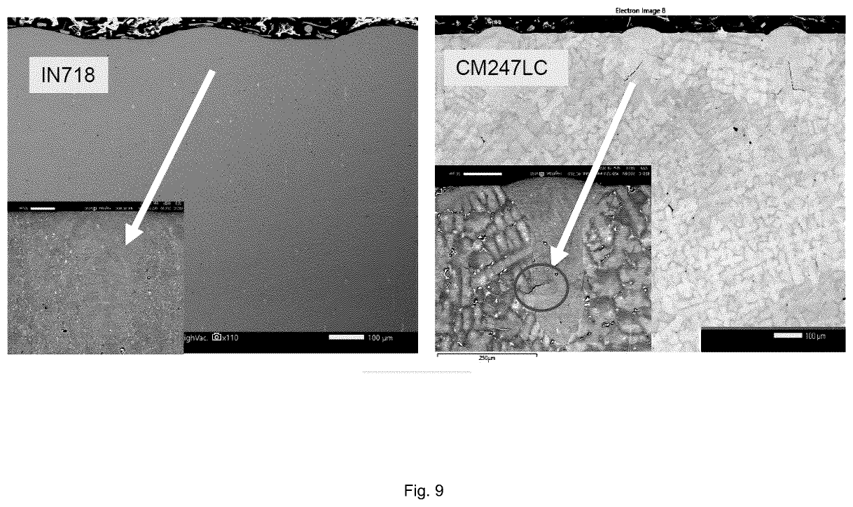

FIG. 9 shows SEM observations of meltpools between IN718 and CM247LC. Processing conditions for the SEM observations are at the laser line powers and scan speeds shown. The SEM observation of microcracks in laser melt pools of IN718 and CM247LC are perfectly in sync with known 3D printability of the two alloys. Therefore, the laser line scans validate results from actual 3-D printing.

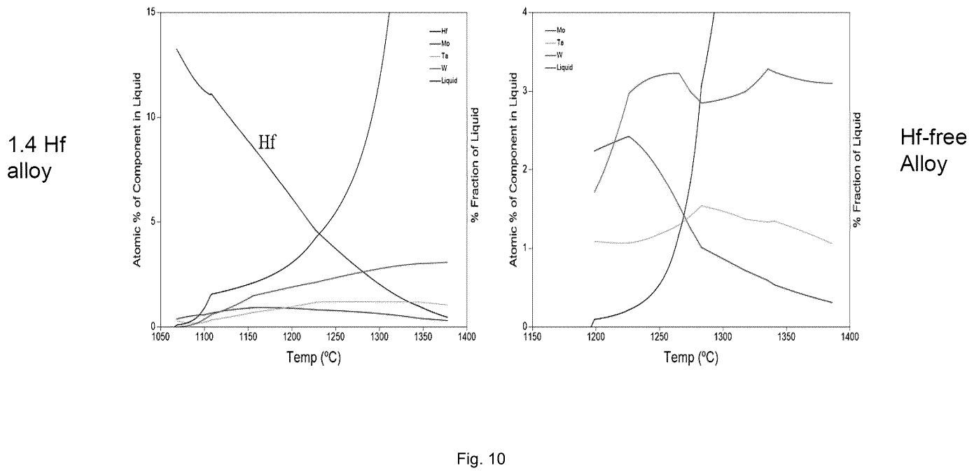

FIG. 10 shows alloy design by demonstrating the effect of Hf as per the Scheil Model. Other carbide forming elements, such as tantalum (“Ta”), Ti, and molybdenum (“Mo”) go up in the last stages of solidification when Hf is removed from the alloy.

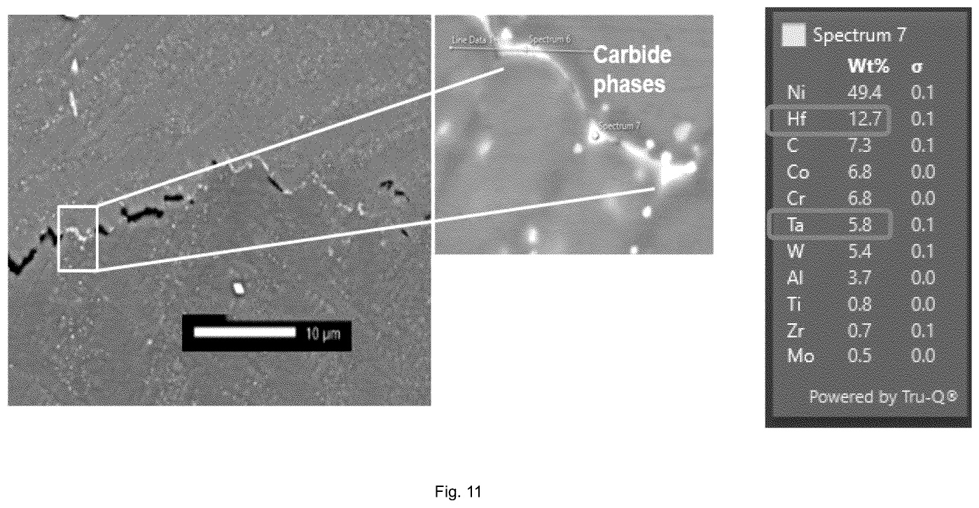

FIG. 11 shows a comparison of SEM microstructure between CM247LC and CM247LCNHf. The laser line scan results indicate that microcracks are present in the meltpools of both alloys regardless of the parameters used for the line scans. Eliminating Hf to prevent the occurrence of Ni₇Hf₂ and accompanied decrease in melting range AT, do not appear to prevent micro cracks, in apparent disagreement with the theoretical analysis.

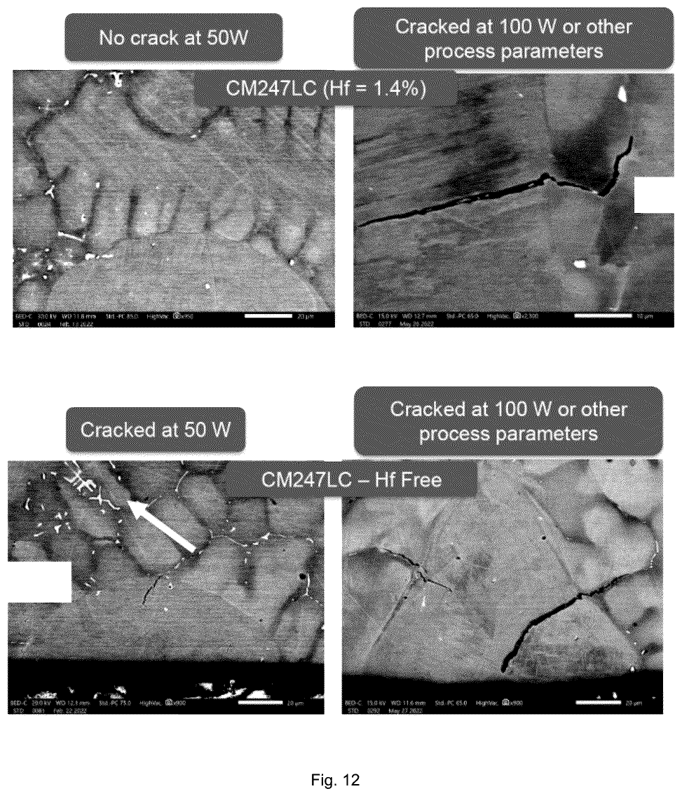

FIG. 12 shows an EDS point analysis along a crack path of CM247LC. The EDS point analysis shows Hf-and Ta-rich carbide phases along the crack path. The microstructure shows that cracking occurs where two sets of columnar boundaries meet, and therefore likely at high angle grain boundary (HAGB). FIG. 12 confirms that removing Hf, which has been claimed as a solution to cracking in CM247LC, does not indeed lead to elimination of cracking.

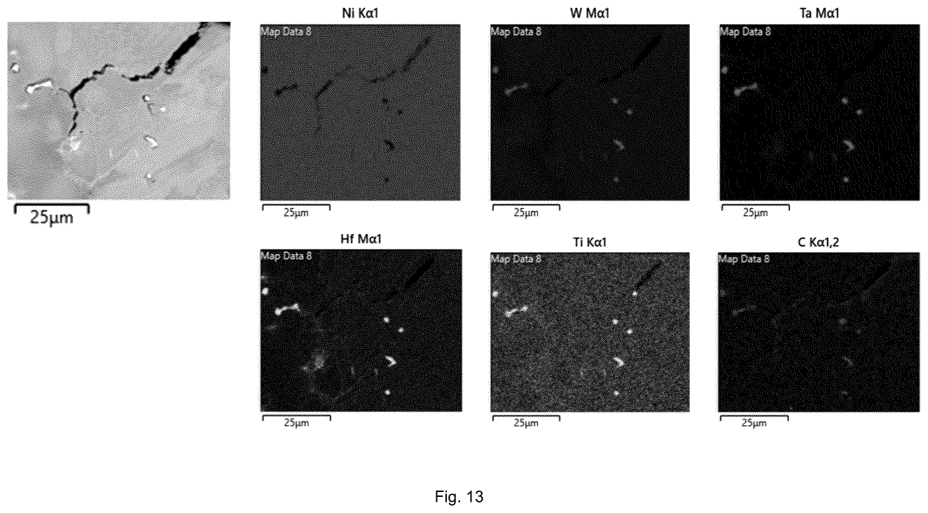

FIG. 13 shows showing elemental maps of HAGBs that are the primary sites for solidification cracking. The crack path shows an abundance of carbides in CM247LC, along with Hf enrichment. Hf is one of the last elements to solidify.

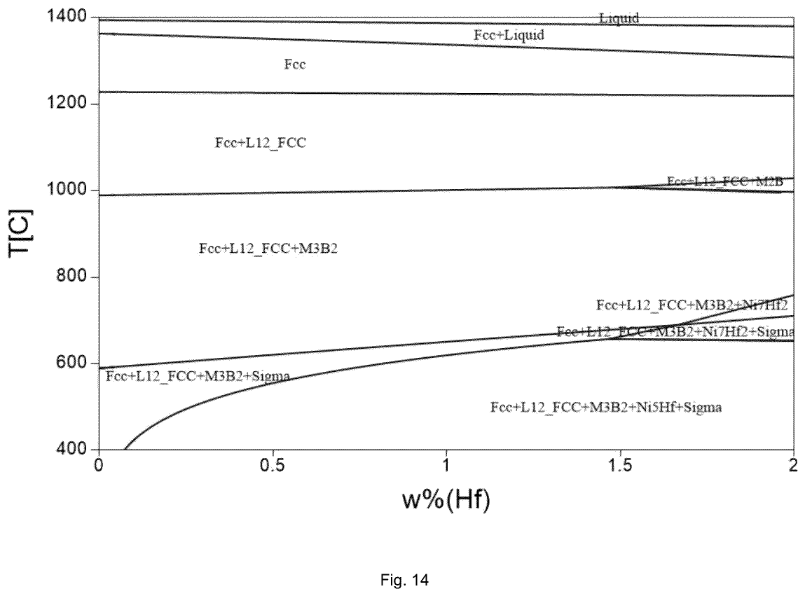

FIG. 14 shows the equilibrium phase diagram for the carbon free material, where the constitutive elements are all of almost identical amounts as CM247LC, except that carbon content is reduced to zero in place of 0.07 wt. % carbon in CM247LC. This alloy is designated as CM247NC (i.e., no carbon). The phase diagram can be compared with FIG. 6 with a composition comprising 0.07 wt % carbon (CM247LC) and demonstrates CM247NC exhibits fewer brittle phases as the composition solidifies.

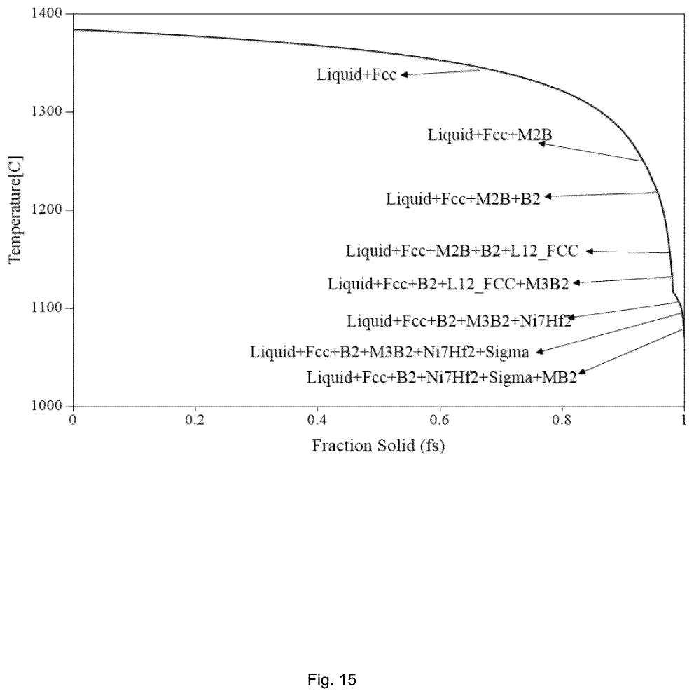

FIG. 15 shows the Scheil diagram for the carbon-free alloy CM247NC (alternately designated as CM247LCNC). Complex carbides like brittle M6C, M23C6, M7C3 are no longer present. In addition, although not shown here, reduced carbon content (example 0.04 or 0.02 wt. % C) leads to reduced carbon in the last remaining liquid, and thereby is anticipated to increase grain boundary strength. We note here that zero carbon content is a very difficult target in the manufacturing industry and so 0.02 wt. % may be a more reasonable target.

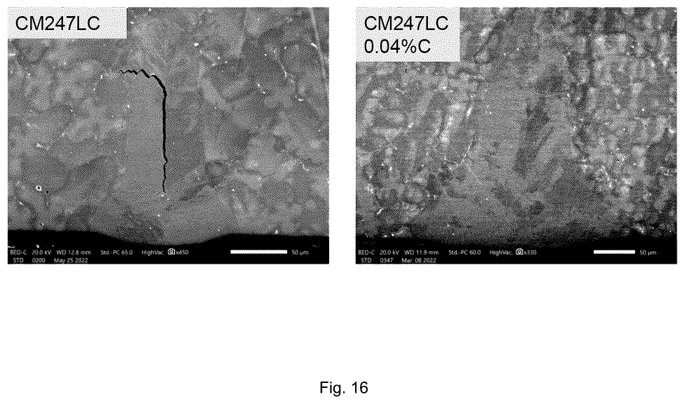

FIG. 16 shows SEM microstructures and cracking behavior of meltpools of CM247LC (0.07 wt. % C) and CM247LC with 0.04% C, which illustrates that a lowering of carbon content reduced the cracking behavior under the rapid solidification conditions typical of laser line scans.

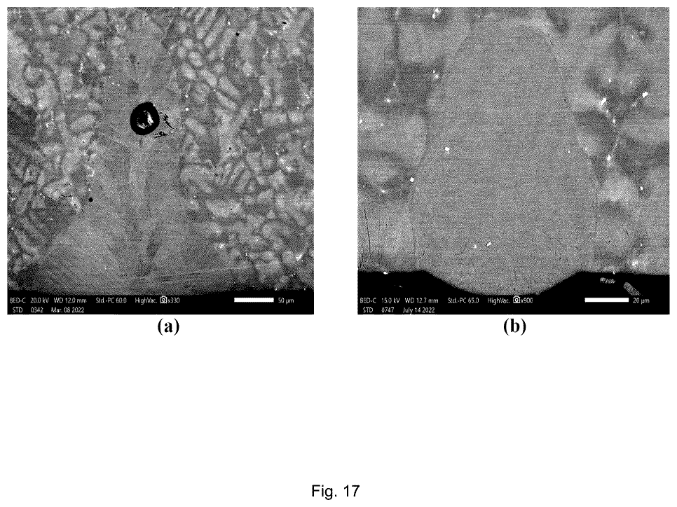

FIG. 17 shows SEM microstructures demonstrating no cracking in different additive manufacturing processing conditions of CM247NCxHf, which contains less than 0.02 wt. % C and approximately 3 wt. % Hf.

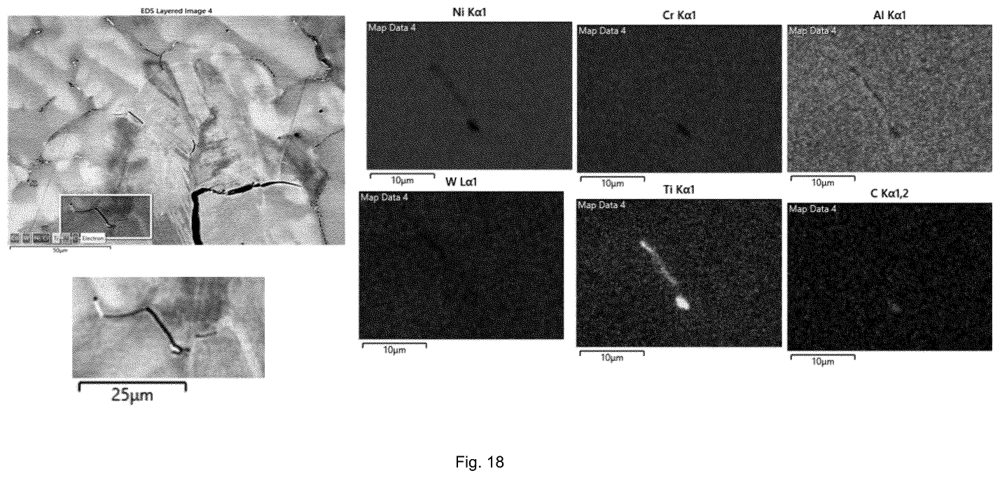

FIG. 18 shows SEM microstructures with cracking for a modified CM247LC composition with no or negligible carbon and with no Hf. The microstructures show that Hf removal is not a solution to mitigate cracking. Note that the precipitates lining the crack path is now rich in Ti.

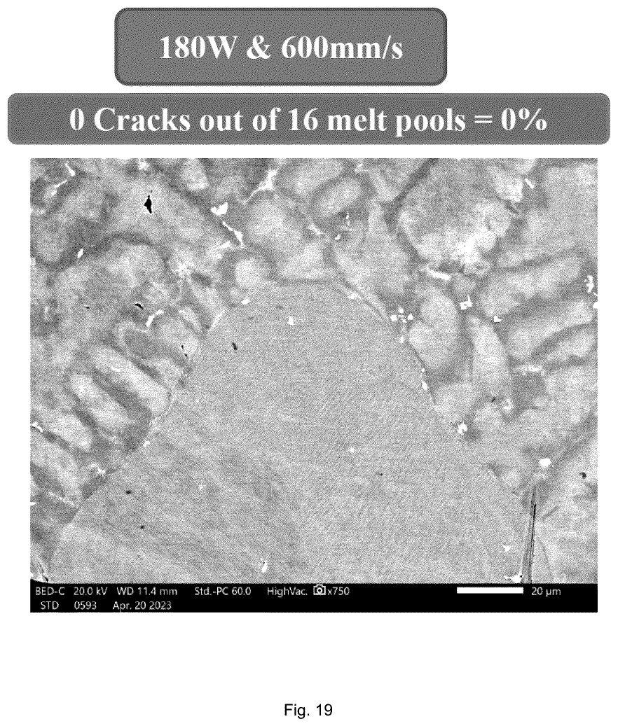

FIG. 19 shows a CMNCxHf meltpool at a processing window of 180 W and 600 mm/s. Zero cracks were identified in 16 melt pools. CMNC implies less than 0.02 wt. % C, and xHf implies approximately 3 wt. % Hf.

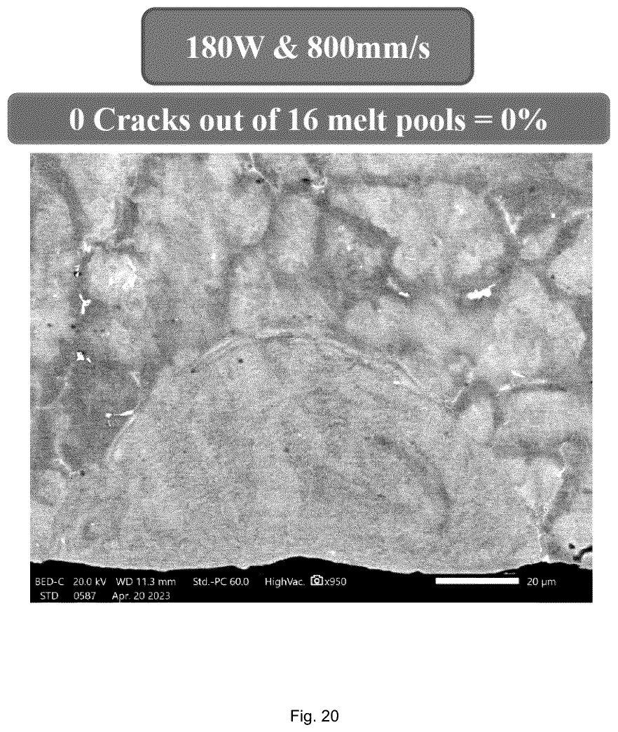

FIG. 20 shows a CMNCxHf meltpool a processing window of 180 W and 800 mm/s. Zero cracks were identified in 16 melt pools. The CMNCxHf alloy comprises no or negligible (e.g., 0.02 wt %) carbon and comprises Hf.

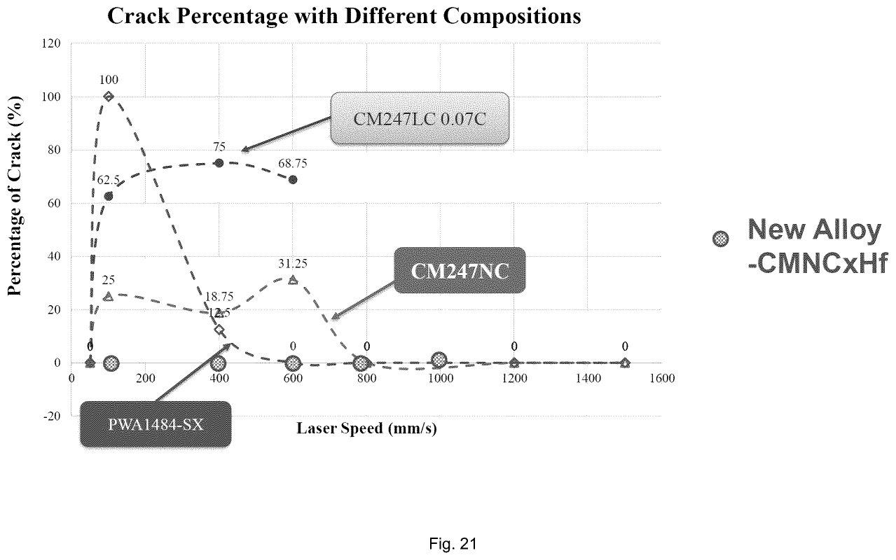

FIG. 21 shows a crack percentage comparison of CMNCxHf, CM247LC 0.07C and CM247NC. FIG. 21 demonstrates that CMNCxHf with less than 0.02 wt. % C and 3 wt. % Hf eliminates cracking over a wide range of processing conditions, and thereby is particularly suitable for additive manufacturing of high volume-fraction γ′ strengthened Ni-base superalloys.

The composition may comprise chromium (“Cr”), cobalt (“Co”), aluminum (“Al”), titanium (“Ti”), molybdenum (“Mo”), tungsten (“W”), tantalum (“Ta”), hafnium (“Hf”), boron (“B”), zirconium (“Zr”), carbon (“C”), nickel (“Ni”), or a combination thereof. Optionally, the composition does not comprise carbon. These other elements impart high strength, creep resistance, toughness, oxidation resistance at temperatures up to 1100° C. in air or other oxidizing environments.

The composition may be at least about 50%, about 50% to about 80%, about 55% to about 75%, about 60% to about 70%, or about 80% Ni by weight. Typically, the nickel in the present composition is the balance. When the present disclosure refers to “by weight” of “wt %” in describing the present composition, one skilled in the art would appreciate that “by weight” or “wt %” refers to by weight of the total composition on a percentage basis.

The composition is what is known to be a low-carbon composition. Accordingly, the present composition comprises less than 0.04, 0.03, 0.02, 0.015 or 0.01% C by weight. The composition may be a no-carbon composition wherein the composition is 0% C by weight.

The composition comprises more Hf by weight than conventional Ni-based compositions. For example, the composition may comprise at least 1.0%, at least about 1.5%, about 1.5% to about 6.0%, about 1.4% to about 4.0%, about 2.0% to about 4.0%, about 2.5% to about 4.5%, about 2.5% to 3.0%, or about 2.0% to about 3.0% Hf by weight.

The composition may comprise at least about 5%, about 5% to about 12%, about 6% to about 11%, about 7% to about 12%, about 7% to about 10%, about 7% to about 9%, about 8% to about 9%, about 8%, about 9%, or about 11% Cr by weight.

The composition may comprise at least about 5%, about 5% to about 14%, about 6% to about 13%, about 7% to about 12%, about 8% to about 11%, about 8% to about 10%, about 9% to about 10%, about 9%, about 10%, about 11%, about 12%, about 13%, or about 14% Co by weight.

The composition may comprise at least about 5%, about 5% to about 15%, about 6% to about 14%, about 6% to about 10%, about 7% to about 13%, about 8% to about 12%, about 8% to about 10%, about 9% to about 11%, about 9%, about 10%, or about 15% W by weight.

The composition may comprise 0 to about 5.0%, 0 to about 2.0%, about 0.1% to about 5.0%, about 0.1% to about 1%, about 0.2% to about 0.9%, about 0.3% to about 0.8%, about 0.4% to about 0.7%, about 0.4% to about 0.6%, about 0.5% to about 0.6%, or about 1%

Mo by weight.

The composition may comprise about 0.5% to about 4%, at least about 1.0%, about 1.0% to about 5.0%, about 1.0% to about 4.0%, about 1.5% to about 4.5%, about 2% to about 4%, about 2.5% to about 3.5%, or about 3.0% to about 3.5% Ta by weight.

The composition may comprise at least about 3%, about 3.0 to about 6.0%, at least about 4%, about 4% to about 8%, about 4% to about 6%, about 4.5% to about 7.5%, about 4.5 to about 5.7%, about 5% to about 7%, about 5.5% to about 6.5%, about 5%, about 6%, about 7%, or about 8% Al by weight.

The composition may comprise at least about 0.1%, about 0.3% to about 1.5%, about 0.5% to about 2.0%, about 0.5% to about 1.2%, about 0.5% to about 0.8%, about 0.6% to about 0.8%, about 0.8% to about 1.1%, or, about 0.6%, about 0.7%, about 0.8%, about 0.9%, about 1.0%, about 1.1%, about 1.2%, about 1.3, about 1.4%, or about 1.5% Ti by weight.

In embodiments, the composition comprises less than about 0.04%, 0% to about 0.03%, 0% to about 0.02%, about 0.01% to about 0.02%, about 0.01%, about 0.015%, about 0.02%, or about 0.025% B by weight.

The composition may comprise 0% to about 2.0%, 0% to about 1.0%, less than 0.05%, less than 0.04%, less than 0.03%, or less than 0.02%, less than 0.01% Nb by weight. In embodiments, the composition comprises 0 to about 3.0%, 0% to about 2.0%,

0% to about 1.0%, less than 0.03%, less than 0.02%, or less than 0.01% Re by weight.

The composition may comprise 0% to about 0.03%, 0% to about 0.02%, at least about 0.005%, about 0.005% to about 0.02%, about 0.01% to about 0.03%, about 0.01% to about 0.02%, about 0.01% to about 0.015%, about 0.01% about 0.02%, about 0.03%, about 0.04%, or about 0.05% Zr by weight.

In embodiments, the composition comprises less than 4000 ppm, less than 2500 ppm, less than 1000 ppm, less than 500 ppm, less than 250 ppm, or less than 200 ppm oxygen (O).

Compositions of the present disclosure surprisingly avoided cracking when used in additive manufacturing methods. Without being bound by a particular theory, the present inventors believe the low carbon content and/or high hafnium content is responsible for this surprising effect. Previous efforts to resolve the aforementioned cracking issue involved eliminating hafnium content. S. Griffiths, H. Ghasemi Tabasi, T. Ivas, X. Maeder, A. De Luca, K. Zweiacker, R. Wróbel, J. Jhabvala, R. E. Logé, C. Leinenbach, Combining alloy and process modification for micro-crack mitigation in an additively manufactured Ni-base superalloy, Additive Manufacturing. 36 (2020) 101443 (which is incorporated by reference in its entirety). The present inventors surprisingly show that increasing hafnium in the present compositions avoided cracking and increased strength.

The method may produce a composition comprising a superalloy. The superalloy may be able to withstand high temperatures, be Ni-based, be produced using an additive manufacturing technique, or a combination thereof. The method may comprise contacting Hf and a Ni-based alloy without the presence of carbon to form a raw powder; pressing the raw powder into a pellet in an inert environment; and melting the pellet to form an alloy. The inert environment may comprise an inert gas including, but not limited to, Ar. The method may further comprise manufacturing the composition over a process window of at least about 700 mm/s, about 700 mm/s to about 1700 mm/s, about 800 mm/s to about 1600 mm/s, about 900 mm/s to about 1500 mm/s, about 1000 mm/s to about 1400 mm/s, about 1100 mm/s to about 1300 mm/s, or about 1700 mm/s with a 180 Watt laser power. The process window may mitigate or prevent the formation of cracks in the composition.

The composition may withstand a temperature of at least about 750° C., preferably about 750° C. to about 1150° C.

Embodiments of the present disclosure provide a technology-based solution that overcomes existing problems with the current state of the art in a technical way to satisfy an existing problem for superalloys susceptible to crack formation due to heat, stress, or oxidizing conditions. Embodiments of the present disclosure achieve important benefits over the current state of the art, such as increased crack resistance. Some of the unconventional steps of embodiments of the present disclosure include manufacturing methods that form a low-carbon or no-carbon superalloy.

### Exemplary Embodiments

Tables 1 to 4 describe exemplary embodiments of the present composition.

TABLE 1

| | Wt % |
|---|---|
| Ni | balance |
| C | <0.04 |
| Cr | 7-12 |
| Co | 7-12 |
| W | 6-10 |
| Mo | 0-5 |
| Al | 3-6 |
| Ti | 0.5-2 |
| Hf | 1.5-6 |
| B | 0.0-0.03 |
| Zr | 0.0-0.03 |
| Nb | 0.0-2 |
| Ta | 0.5-4 |
| Re | 0.0-3 |
| O | <4000 ppm |

TABLE 2

| | Wt % |
|---|---|
| Ni | 59-62 |
| C | <.04 |
| Cr | 7-9 |
| Co | 8-10 |
| W | 8-10 |
| Mo | 0-2 |
| Al | 4-6 |
| Ti | 0.5-0.8 |
| Hf | 1.4-4.0 |
| B | 0.00-0.02 |
| Zr | 0.00-0.02 |
| Nb | 0.0-1.0 |
| Ta | 0.5-4 |
| Re | 0.0-1.0 |
| O | <1000 ppm |

TABLE 3

| | Wt % |
|---|---|
| Ni | balance |
| C | <0.03 |
| Cr | 7-9 |
| Co | 8-10 |
| W | 8-10 |
| Mo | 0.4-6 |
| Al | 4.5-5.7 |
| Ti | 0.6-0.8 |
| Hf | 2-4 |
| B | 0.01-0.02 |
| Zr | 0.01-0.02 |
| Nb | 0.0-1.0 |
| Ta | 1-4 |
| Re | 0.0-1.0 |
| O | <500 ppm |

TABLE 4

| | Wt % |
|---|---|
| Ni | balance |
| C | 0.005-0.015 |
| Cr | 8-9 |
| Co | 9-10 |
| W | 9-10 |
| Mo | 0.4-0.6 |
| Al | 5.5-5.75 |
| Ti | 0.7-0.8 |
| Hf | 2-3 |
| B | 0.01-0.02 |
| Zr | 0.01-0.03 |
| Nb | 0.01-0.05 |
| Ta | 3-4 |
| Re | <0.01 |
| O | <200 ppm |

### Methods of Manufacturing the Present Composition

The present method involved making arc melted buttons of specific compositions as described in FIG. 8, and then running laser line scans of the cross section at different laser power and speed settings. This was followed with microstructural examinations to quantify the number of melt pools (formed by laser line scanning) with cracks. In this way the optimized composition was determined.

One skilled in the art would be knowledgeable regarding how to prepare based powders of the present disclosure. For example, raw elemental materials can be processed in sufficient amounts to arrive at an alloy comprising nickel, less than 0.03 wt % carbon and 1.5 to 6.0% hafnium, or any of the other embodiments described in the present disclosure, e.g., the embodiments of Tables 1-4. Alloys and superalloys of the present disclosure can be vacuum induction melted (VIM) followed by vacuum arc remelting (VAR) to prevent oxidation. Ingots of the composition are then conventionally cast in the form of a rod or small chips that are then fed into an atomizer chamber where the molten metal is sprayed (atomized) into small droplets that then break up and solidify into micron sized solidified particles. The atomization occurs in inert atmosphere such as Ar, N2 or He. Following confirming the identity of the composition, the powders are sieved into different size ranges depending on the type of additive manufacturing technique that will be used. Thus, LPBF techniques use powders in the range 10-63 microns (micrometers), while DED machines use powders of size 70-150 microns. Alternatively, different mixed powders may be processed to arrive at a composition of the present disclosure.

### Methods of Using the Present Composition

The alloys of the present disclosure are particularly suitable for use in additive manufacturing methods, including methods utilizing Laser Powder Bed Fusion (LPBF) machines, Directed Energy Deposition (DED), Electron Beam Melting (EBM), and Binder Jet Technique. One skilled in the art would be knowledgeable enough to optimize these methods for superior results, and machine learning (ML) techniques can be incorporated for predicting microstructure and mechanical properties for a given set of process condition.

The base powder for use with the aforementioned additive manufacturing techniques may be in the form of an alloy powder as previously described. Alternately, the base powder may be in the form of a mixture of powders in sufficient amounts to account for elemental loss due vaporization or other losses during fabrication of the 3-D printed product. Alternatively, wires may be fabricated from powders of the present composition via standard techniques to be used in 3D printing.

In other embodiments, the present composition can be used to weld superalloys, particularly superalloys containing a high volume-faction of γ′ phase.

### EXAMPLES

### Example 1

A phase diagram (“CALPHAD”) approach and solidification was calculated to assess theoretically the influence of alloy composition on crack susceptibility. Following an initial screening, the superalloy CM247 LC was used to access the viability of the screened compositions. Laser line scans of arc melted buttons of CM247 LC were performed on an arc melter using a laser powder bed fusion (“LPBF”) system. This was followed up with metallographic studies of the solidified melt pool cross-section, for microstructure and defects. It was observed that cracks formed in laser melt pool regions of CM247 LC were often associated with carbides rich in Hf, W, and Ta. Following studies on other candidate alloy compositions, we determined that alloys with 0 to 0.02 wt % carbon were crack free for laser scan speeds of 800 mm/sec and above. At lower scan speeds, cracks were still observed. In other words, carbon-free material was not the complete solution to elimination of cracks during 3-D printing. Returning to the Kou model, it suggested that crack susceptibility could be reduced further by increasing the Hf content. Accordingly, the Hf content was increased to 3 wt. % while maintaining carbon below 0.02 wt. %. This combination of negligible carbon and 3 wt. % Hf led to the crack-free material illustrated in FIG. 21. Even higher Hf can provide higher resistance to cracking; however one must note that Hf is very expensive and can be pose difficulties for making the initial ingot.

### Example 2

The percent of laser melt pools with cracks among total number of melt pools of the same composition and process condition (laser power and laser scan velocities) were assessed. Curves of percentage cracks as a function of laser scan speed (at 180 W laser power) were plotted and compared with curves from other alloys. These curves provided a measure of alloy performance, which was used to arrive at the desired alloy composition that best mitigated cracks. Specifically, alloy and scan speeds with zero percent cracks were identified. Identical line scans of the superalloy Inconel 718 confirmed that the alloy was free of cracks in melt pool regions. Similarly, melt pool studies showed cracks in conventional CM247 LC samples.

### Example 3

Powders are manufactured to meet the specifications of Table 3. The powders are 3D printed using a LPBF technique with an Aconity Midi LPBF machine. Processing conditions, such as laser power, laser speeds, hatch spacing, are optimized to print articles of different topologies. The articles produced by LPBF using the composition of Table 3 are devoid of cracks and exhibit desirable strength characteristics.

### Example 4

The powders of Example 3 are subjected to heat treatment up to 1100° C. to assess performance under elevated temperatures and mimic heat conditions found in additive manufacturing methods. After undergoing heat treatment, compositions of the present disclosure do not exhibit cracking typically seen in prior art compositions that can be 3D printed.

Although the present composition has been described in detail with particular reference to these embodiments, other embodiments can achieve the same results. Variations and modifications of the present composition and methods of making the same will be obvious to those skilled in the art and it is intended to cover in the appended claims all such modifications and equivalents. The entire disclosures of all references, applications, patents, and publications cited above are hereby incorporated by reference.

1. An alloy composition comprising nickel, less than 0.03 wt % carbon and 1.5 to 6.0% hafnium.

2. The alloy composition of claim 1, comprising less than 0.02 wt % carbon.

3. The alloy composition of claim 2, comprising less than 0.015 wt % carbon.

4. The alloy composition of claim 1, comprising 1.5 to 4.0 wt % hafnium.

5. The alloy composition of claim 4, comprising 2.0 to 4.0 wt % hafnium.

6. The alloy composition of claim 5, comprising 2.5 to 3.0 wt % hafnium.

7. The alloy composition of claim 1, less than 0.02 wt % carbon and 2.0 to 3.0 wt % hafnium.

8. The alloy composition of claim 1, further comprising about 7 to about 12 wt % chromium.

9. The alloy composition of claim 8, further comprising about 7 to about 12 wt % cobalt.

10. The alloy composition of claim 9, further comprising about 6.0 to 10.0 wt % tungsten.

11. The alloy composition of claim 10, further comprising about 3.0 to about 6.0 wt % aluminum.

12. The allow composition of claim 11, further comprising 0.5 to 2 wt % titanium.

13. The alloy composition of claim 12, further comprising 0.5 to 4.0 wt % tantalum.

14. The alloy composition of claim 13, further comprising 5.0 or less wt % molybdenum.

15. The alloy composition of claim 14, further comprising less than 0.03 wt % of boron, less than 0.03 wt % zirconium, less than 2.0 wt % niobium, and less than 3.0 wt % rhenium.

16. The alloy composition of claim 15, wherein the composition comprises less than 4000 parts per million of oxygen.

17. The alloy composition of claim 1, wherein the composition is suitable for use in additive manufacturing methods.

18. The alloy composition of claim 1, wherein the composition is a powder.

19. An article manufactured in an additive manufacturing method using the alloy composition of claim 1.

20. A method of manufacturing an article by additive manufacturing, comprising using the composition of claim 1, wherein the additive manufacturing is selected from the group comprising Laser Powder Bed Fusion (LPBF), Directed Energy Deposition (DED), Electron Beam Melting (EBM), and Binder Jet Technique.
